(19) United States
(12) Patent Application Publication
(10) Pub. No.: US 2009/0112794 A1
(43) Pub. Date: Apr. 30, 2009

(54) ALIASED KEYS FOR FEDERATED DATABASE QUERIES

(76) Inventors: Richard Dean Dettinger, Rochester, MN (US); Jan Theresa Karels, Rochester, MN (US); Richard Joseph Stevens, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/930,937

(22) Filed: Oct. 31, 2007

(51) Int. Cl. G06F 17/30

(52) U.S. Cl. 707/2; 707/E17.014

(57) ABSTRACT

Embodiments of the invention provide techniques for performing federated queries of data records stored in multiple data sources. In one embodiment, an aliased key table may be configured to store relationships between key fields of multiple data sources. The aliased key table may specify a mapping function to translate a value of one key field to an equivalent value of a second key field. The mapping function may be used with a mapping table storing sets of key values of different data sources, with each set corresponding to a given entity. In another embodiment, the mapping function may call a web service configured to translate key values. In yet another embodiment, federated queries may be specified in terms of attributes, which may be matched to key values.

### BACKGROUND OF THE INVENTION

1. Field of the Invention

The present invention generally relates to data processing and computer database systems. More particularly, embodiments of the invention are related to techniques for performing federated database queries.

2. Description of the Related Art

Electronic data is pervasive; electronic data records have been created to capture details about almost any conceivable transaction or event. Medical records, for example, contain various data about patients, including medical history data, test data, medication data, etc.

One of the problems created by the proliferation of data is the management and accessibility of the data. Currently, electronic data records are often stored in multiple unrelated data stores, where each data store may be managed by a different owner. Following the example of medical records, a health care provider may maintain an internal set of records for individual patients treated by the provider. Similarly, a pharmacist may maintain records for prescriptions dispensed to a patient at a particular location or pharmacy chain. Another health care provider, however, will not normally have on-demand access to the records of either. As illustrated by even this simple example, data records related to a single entity (i.e., patient) may be spread across many data sources.

Providing access to a complete collection of electronic data records from such widely distributed data stores has proven to be very difficult.

### SUMMARY OF THE INVENTION

Embodiments of the invention provide techniques for performing federated queries of data records stored in multiple data sources. One embodiment of the invention includes a computer-implemented method for processing a federated query. The method generally includes receiving the federated query, where the federated query requests data records stored in at least two data sources. The method may also include determining one or more conditions included in the federated query. The one or more conditions specify a first key field from a first data source and a second key field from a second data source. The method may also include determining an alias relationship between the first key field and the second key field. The method may also include determining, based on the alias relationship, a mapping of key values of the first key field to key values of the second key field. The mapping may specify key values of the first key field and key values of the second key field that identify the same entity. The method may also include generating a query plan for the federated query. The query plan includes the mapping of key values of the first key field to key values of the second key field. The method may also include outputting the generated query plan.

Another embodiment of the invention includes a computer-readable storage medium including a program, which when executed on a processor performs an operation for generating a query plan for a federated query. The operation generally includes receiving the federated query. The federated query may request data records stored in at least two data sources retrieve data records stored in at least two data sources. The operation may also include determining one or more conditions included in the federated query. The one or more conditions specify a first key field from a first data source and a second key field from a second data source. The operation may also include determining an alias relationship between the first key field and the second key field. The operation may also include determining, based on the alias relationship, a mapping of key values of the first key field to key values of the second key field. The mapping may specify key values of the first key field and key values of the second key field that identify the same entity. The operation may also include generating a query plan for the federated query. The query plan includes the mapping of key values of the first key field to key values of the second key field. The operation may also include outputting the generated query plan.

Still another embodiment of the invention includes a system having a federated database, a processor, and a memory containing a program, which when executed by the processor is configured to generate a query plan for a federated query of the federated database. The federated query may request data records stored in at least two data sources retrieve data records stored in at least two data sources. The program may generally be configured to receive the federated query and determine one or more conditions of the federated query. The one or more conditions specify a first key field from a first data source and a second key field from a second data source. The program may be further configured to determine an alias relationship between the first key field and the second key field. The program may be further configured to determine, based on the alias relationship, a mapping of key values of the first key field to key values of the second key field. The mapping may specify key values of the first key field and key values of the second key field that identify the same entity. The program may be further configured to generate a query plan for the federated query. The query plan includes the mapping of key values of the first key field to key values of the second key field. The program may be further configured to output the generated query plan.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments illustrated by the appended drawings. These drawings, however, illustrate only typical embodiments of the invention and are not limiting of its scope, for the invention may admit to other equally effective embodiments.

FIG. 1 is a functional block diagram illustrating an exemplary computing and data communications environment, according to one embodiment of the invention.

FIG. 2 illustrates a conceptual view of an aliased keys table, according to one embodiment of the invention.

FIG. 3 illustrates a conceptual view of a mapping table, according to one embodiment of the invention.

FIG. 4 is a flow diagram illustrating a method for performing a federated query using aliased keys, according to one embodiment of the invention.

FIG. 5 is a flow diagram illustrating a method for performing a parameter-based federated query using aliased keys, according to one embodiment of the invention.

### DETAILED DESCRIPTION OF THE PREFERRED EMBODIMENTS

A data federation enables data records stored in multiple data sources to be searched and retrieved as a group. Thus, a federated query may simultaneously retrieve data records related to an entity from multiple data sources. For example, a federated query may be used to retrieve medical records related to a given patient from multiple medical databases. However, in some situations, data federations may be difficult to set up. In some cases, this occurs because different data sources use different key data to identify an entity. For example, key fields of different data sources may have different field names or may use different data types. For example, one medical database may identify patients by a key field of “PATIENT_NUM” storing a numeric code, while a different medical database may identify patients by a key field of “CLIENT_ID” storing an alphabetic identification code. In such cases, it may be difficult to link records of different data sources that are related to the same underlying entity (e.g., records related to the same patient), as is required to perform federated queries.

Embodiments of the invention provide techniques for performing federated queries of data records stored in multiple data sources. In one embodiment, an aliased key table may be configured to store relationships between key fields of multiple data sources, thus enabling one key field to be used as an alias to another key field. Further, the aliased key table may specify a mapping function to translate a value of one key field to an equivalent value of a second key field. In one embodiment, a mapping function may be used with a mapping table storing sets of key values of different data sources, with each set corresponding to a given entity. In another embodiment, a mapping function may call a web service configured to translate key values. In yet another embodiment, federated queries may be specified in terms of attributes. Such attributes may be matched to key values, which may then be used to perform a federated query. Thus, embodiments of the invention may enable a federated query to be performed across multiple data sources having different key fields and key values.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive and DVDs readable by a DVD player) on which information is permanently stored; and (ii) writable storage media (e.g., floppy disks within a diskette drive, a hard-disk drive or random-access memory) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

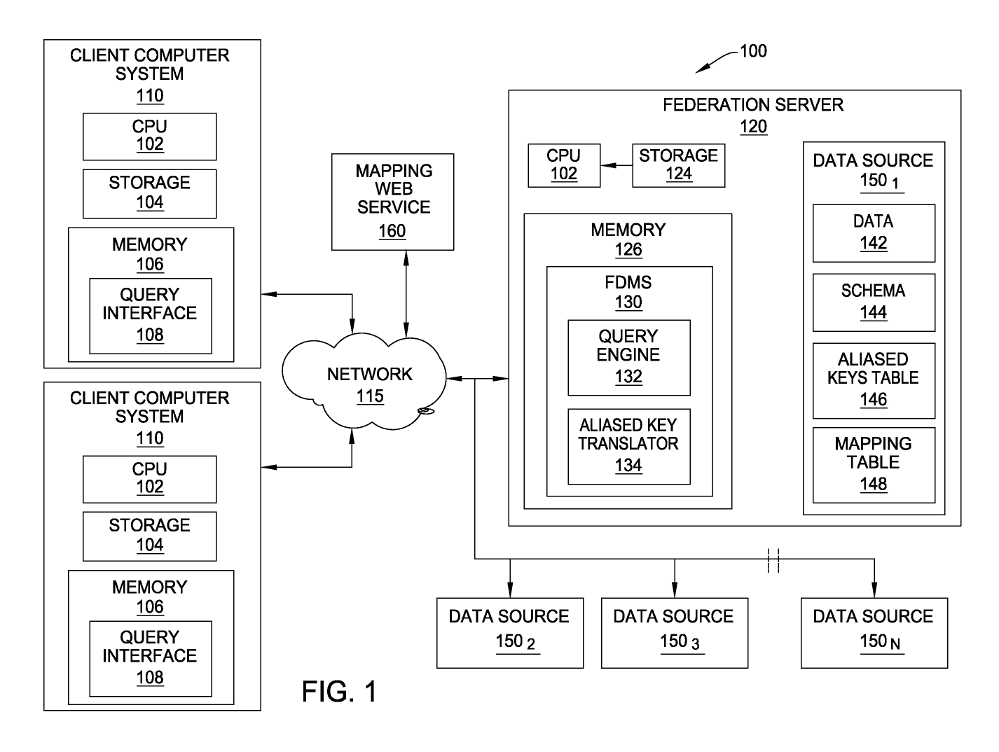

FIG. 1 is a functional block diagram illustrating an exemplary computing and data communications environment 100, according to one embodiment of the invention. As shown, computing environment 100 includes two client computer systems 110 and 112, network 115, a federation server 120, a mapping web service 160, and multiple data sources 150_{1-N}. In one embodiment, the computer systems illustrated in environment 100 may include existing computer systems, e.g., desktop computers, server computers laptop computers, tablet computers, and the like. The computing environment 100 illustrated in FIG. 1, however, is merely an example of one computing environment. Embodiments of the present invention may be implemented using other environments, regardless of whether the computer systems are complex multi-user computing systems, such as a cluster of individual computers connected by a high-speed network, single-user workstations, or network appliances lacking non-volatile storage. Further, the software applications illustrated in FIG. 1 and described herein may be implemented using computer software applications executing on existing computer systems, e.g., desktop computers, server computers, laptop computers, tablet computers, and the like. However, the software applications described herein are not limited to any currently existing computing environment or programming language, and may be adapted to take advantage of new computing systems as they become available.

As shown, client computer systems 110 and 112 each include a CPU 102, storage 114 and memory 106, typically connected by a bus (not shown). CPU 102 is a programmable logic device that performs all the instruction, logic, and mathematical processing in a computer. Storage 104 stores application programs and data for use by client computer systems 110 and 112. Storage 104 includes hard-disk drives, flash memory devices, optical media and the like. The network 115 generally represents any kind of data communications network. Accordingly, the network 115 may represent both local and wide area networks, including the Internet. The client computer systems 110 and 112 are also shown to include a query tool 108. In one embodiment, the query tool 108 is software application that allows end users to access information stored in a database (e.g., data source 150₁). Accordingly, the query tool 108 may allow users to compose and submit a query to a database system, which, in response, may be configured to process the query and return a set of query results. The query tool 108 may be configured to compose queries in a database query language, such as Structured Query Language (SQL). However, it should be noted that the query tool 108 is only shown by way of example; any suitable requesting entity may submit a query (e.g., another application, an operating system, etc.).

In one embodiment, federation server 120 includes a CPU 122, storage 124, memory 126, a data source 150₁, and a federated database management system (FDMS) 130. FDMS 130 may be configured to receive and execute federated queries data stored in multiple data sources. The data being queried may be stored on federation server 120, such as in data source 150₁, or may be located in external data sources accessed via network 115. Such external data sources are illustrated in FIG. 1 by a set of multiple data sources 150_{2-N}. For example, FDMS 130 may receive a federated query composed in query tool 108, and may return query results based on data stored in data sources 150_{1-N}. In one embodiment, federated queries may be configured to specify which data sources 150_{1-N} to retrieve data from. For example, a federated query composed using SQL may include a SELECT clause specifying fields from multiple data sources, or may include a FROM clause specifying the data sources to query. Alternatively, system settings may be used to specify the data sources 150_{1-N} to use in performing a federated query. For example, FDMS 130 may include a system setting specifying the data sources used for all federated queries performed by FDMS 130.

Illustratively, data source 150₁ includes data 142, schema 144, an aliased keys table 146 and a mapping table 148. In one embodiment, data source 150₁ may represent a relational database. Data 142 represents the substantive data stored by data source 150₁. Schema 144 represents the structure of the elements of data source 150₁ (i.e., tables, fields, data types, etc.). Schema 144 may also specify key fields of the data source 150₁, meaning fields that store unique values to identify the entities described by records of the data source 150₁. Additionally, data sources 150_{2-N} may be configured in a similar manner to data source 150₁.

As shown, FDMS 130 includes a query engine 132 and an aliased key translator 134. Query engine 132 may be configured to process federated queries submitted by a requesting application (e.g., a query generated using query tool 108) and to return a set of query results to the requesting application. In one embodiment, a federated query may include a key condition, meaning a key field and key value used to identify a given entity. The key condition may include the key field and key value that are used natively (i.e., without translation) within a given data source 150_{1-N}. Aliased key translator 134 may be configured to identify data records of multiple data sources 150_{1-N} that correspond to the entity matching the key condition. To make this identification, aliased key translator 134 may interact with aliased keys table 146 to determine the key fields used in each data source. Further, aliased key translator 134 may interact with mapping table 148 to determine the key values that identify the entity in each data source.

In one embodiment, aliased keys table 146 represents a data structure configured to store relationships between key fields of different data sources 150_{1-N} Aliased key translator 134 may use such related key fields (hereafter referred to as “aliased key fields”) to identify records of different data sources 150_{1-N} that correspond to common entities.

Additionally, to retrieve data records related to a particular entity, the key values that identify the entity in each data source 150_{1-N} may be required. In one embodiment, mapping table 148 represents a data structure which may be configured to store matched sets of key values. Each set of mapping table 148 may correspond to a given entity, and each key value of a set may be used to identify the entity in a given data source 150_{1-N}. In one embodiment, aliased key translator 134 may use mapping table 148 to translate key values across data sources.

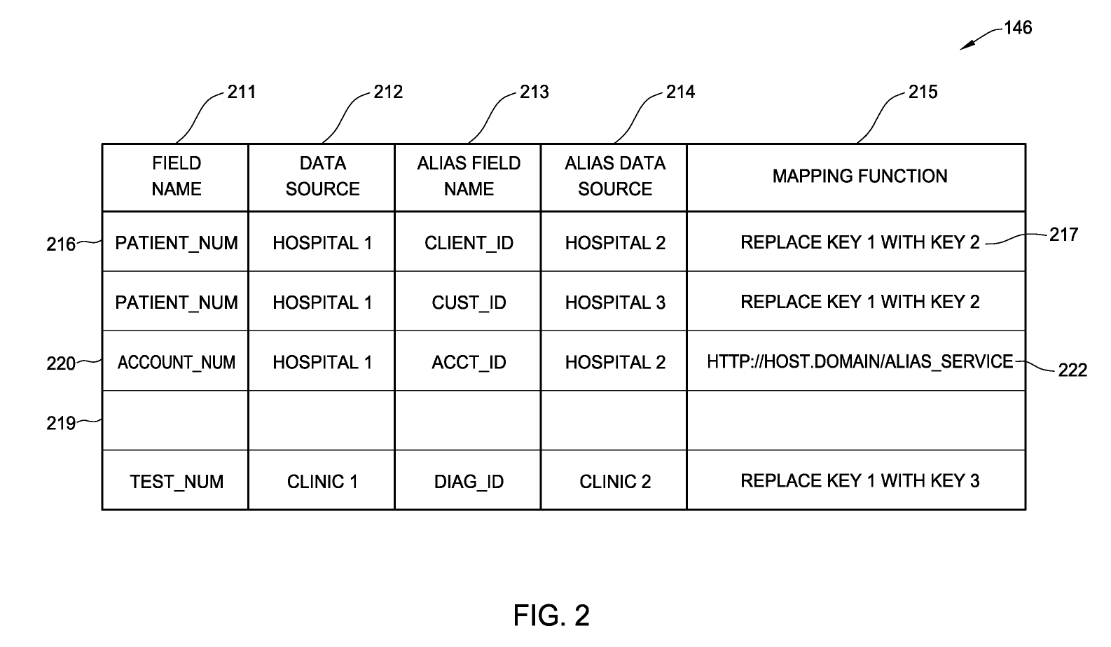

FIG. 2 illustrates one embodiment of aliased keys table 146. As shown, aliased keys table 146 includes a FIELD NAME column 211, a DATA SOURCE column 212, an ALIAS FIELD NAME column 213, an ALIAS DATA SOURCE column 214, and a MAPPING FUNCTION column 215. By way of example, consider a first row 216. The values stored in the columns 211 and 212 of row 216 indicate that the field “PATIENT_NUM” is a key field of the data source “HOSPITAL 1.” Further, the columns 213 and 214 indicate that the key field “CLIENT_ID” of the data source “HOSPITAL2” is an alias to the key field “PATIENT_NUM.” In other words, the records of data sources “HOSPITAL1” and “HOSPITAL2” may be linked by using the respective key fields “PATIENT_NUM” and “CLIENT_ID.” Note, by use of aliased keys table 146, key fields of different data sources may be linked even if they do not have the same field name. Row 219 represents multiple omitted rows of mapping table 146

In one embodiment, aliased keys table 146 may include mapping functions configured to link key values of different data sources that identify a particular entity. For example, as illustrated in FIG. 2, the MAPPING FUNCTION column 215 of row 216 stores a mapping function 217, which states “REPLACE KEY1 WITH KEY2.” Mapping function 217 generally illustrates a type of mapping functions which are configured to equate a key value of one data source to a key value of a second data source. Such mapping functions may be configured to use existing programming languages or functions. For example, mapping function 217 may be written as the following SQL query:

SELECT KEY2 FROM MAPPING_TABLE WHERE KEY1=INPUT

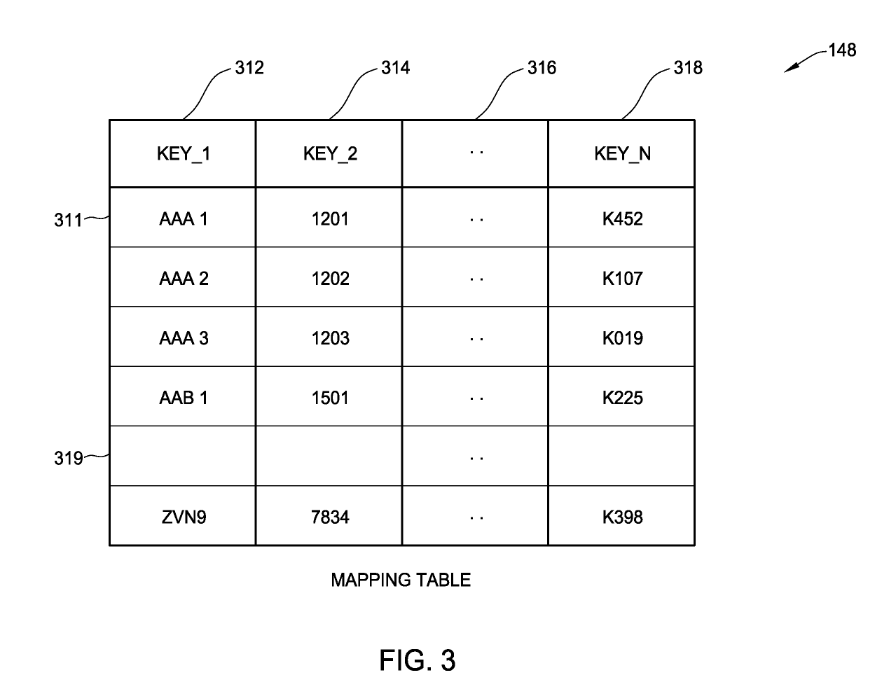

In the above example, mapping function 217 is configured to use the fields of mapping table 148. FIG. 3 illustrates one embodiment of mapping table 148. As shown in FIG. 3, mapping table 148 includes multiple rows, with each row representing a set of key values for identifying a single entity. Mapping table includes key columns 312, 314, and 318, where each column represents a key field for a different data source 150. That is, each row may store data values mapping a key field value for an entity in a first data source 150 to a key field value representing the same entity in records of a second data source 150. For example, row 311 represents a set of key values of a single entity, with the key value “AAA1” of column KEY_1 used in a first data source, and the key value “1201” of column KEY_2 used in a second data source. For the sake of clarity, column 316 represents multiple omitted columns, and row 319 represents multiple omitted rows of mapping table 148. In one embodiment, mapping function 217 may be inserted into a query plan for a federated query. That is, rather than referencing specific key values, the query plan may be composed using a mapping function 217, such that mapping function 217 is performed when the query plan is executed. In this embodiment, mapping function 217 may be written as a SQL query, as in the example shown above.

In another embodiment, key values may be equated by using a mapping web service. For example, row 220 of aliased keys table 146 stores a mapping function 222, which includes a network address for a mapping web service 160 (illustrated in FIG. 1). Mapping web service 160 may be configured to receive a first key value representing an entity in a first data source 150 over network 115, and to return a second key value corresponding to the same entity a second data source 150. Thus, mapping function 222 may be used to call mapping web service 160 in order to equate the key values stored in the key fields shown in row 220.

In yet another embodiment, FDMS 130 may be configured to process federated queries which include attribute conditions. Such federated queries may be specified with attributes describing the entity desired in the query results, instead of key conditions identifying the entity. For example, a user of query tool 108 may compose the following federated query in SQL:

SELECT*WHERE NAME=“Smith” AND BIRTH=“09/29/1965”

In this example, the query includes attribute conditions which specify a name and birth date of the entity for which records are sought. Note that the NAME and BIRTH fields may not be key fields in any of the data sources 150_{1-N}. In this embodiment, the FDMS 130 may be configured to determine a key condition identifying the entity corresponding to the attribute conditions of the query. The key condition may then be used by aliased key translator 134 to determine alias keys, as described above. That is, the key condition determined from the attribute conditions may be used as if it was a key condition initially included in the federated query.

However, in situations where attribute conditions included in a query are insufficiently precise to identify a particular entity, it may not be feasible to determine a key condition to replace the attribute conditions. In such situations, an alert message may be presented to a user submitting the query. In one embodiment, the alert message may indicate only the failure to determine a key condition. In another embodiment, the alert message may be configured to include additional attributes that may suffice to determine a key condition. Thus, the user may use this information to submit a second query including the additional attributes required to properly identify the entity. In yet another embodiment, the user may be presented with an interface screen listing the multiple entities that match the attribute condition, along with additional descriptive data for each entity (e.g., name, address, etc.). The additional descriptive data may be configured to enable the user to identify the desired entity. The user may select the entity from the presented list. The query may then be completed for the selected entity.

Note that FIGS. 1-3 are included for illustrative purposes only, and are not limiting of the invention. For example, the functionality of aliased keys table 146 and mapping table 148 may be implemented in data structures other than tables, for instance XML data files. In another example, mapping web service 160 may be configured to translate both key field names and key field values across multiple data sources 150_{1-N}. This and other embodiments may be adapted to suit the needs in a particular case.

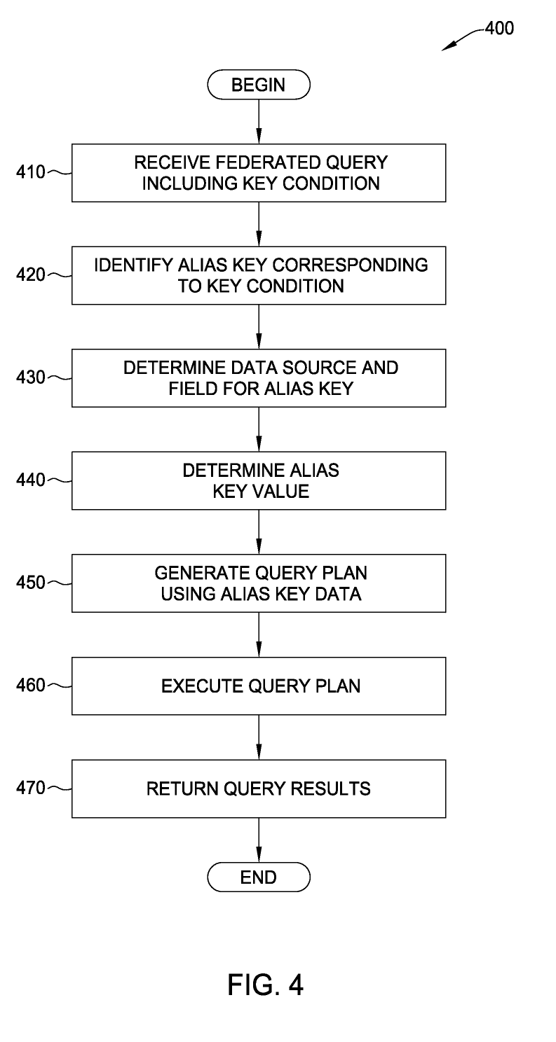

FIG. 4 is a flow diagram illustrating a method 400 for performing a federated query using aliased keys, according to one embodiment of the invention. Persons skilled in the art will understand that, even though the method is described in conjunction with the systems of FIGS. 1-3, any system configured to perform the steps of method 400, in any order, is within the scope of the present invention.

As shown, method 400 begins at step 410, where a federated query including a key condition is received. That is, a query may be received requesting data from multiple data sources. The query may include a key condition specifying a key field and key value. Optionally, the query may include multiple key conditions, corresponding to multiple data sources 150_{1-N}. For example, a federated query including a key condition may be created by a user interacting with a query tool 108 and received by a FDMS 130 on a federation server system 120. The key condition may include a key field and key value used natively (i.e., without translation) in one (or more) of multiple data sources 150_{1-N}. In another example, a federated query may include a first condition for a key field of data source 150₁ and a second condition for a key field of data source 150₂. At step 420, an alias key corresponding to the key condition is determined. The alias key may be determined, for example, by aliased key translator 136 interacting with aliased keys table 146, as illustrated in FIG. 1. In the case that the query includes multiple key conditions, it is determined whether the key fields referenced in the key conditions are alias keys.

At step 430, the data source and field of the alias key may be determined. That is, a key field of a second data source may be determined be equivalent to the key field of the key condition. This determination may be made, for example, by using an aliased keys table 146. One embodiment of the aliased keys table 146 is illustrated in FIG. 2. Using FIG. 2 as an example, assume the key condition includes the key field of “PATIENT_NUM” and the key value of “HOSPITAL1.” In this example, step 430 may result in determining an alias key field of “CLIENT_ID” and a data source of “HOSPITAL2.”

At step 440, the key value of the key condition may used to determine an alias key value. That is, the alias key value identifies the same entity as the key value of the key condition. Step 440 may be performed using a mapping function configured to determine equivalent key values. In one embodiment, the mapping function may refer to a mapping table storing equivalent key values. For example, the mapping function 217 (illustrated in FIG. 2) specifies equivalent key values stored in mapping table 148 (illustrated in FIG. 3), namely from a KEY1 field value and a KEY2 field value. In another embodiment, the mapping function may call a web service configured to equate key values of different data sources (e.g., mapping web service 160 illustrated in FIG. 1).

At step 450, a query plan to perform the federated query may be generated using the alias key data (i.e., the alias key data source, the alias key field, and the alias key value). In other words, a query plan may be generated to retrieve data from multiple data sources, without requiring that the key data of multiple data sources be specified in the initial query. Step 450 may be performed, for example, by FDMS 130 illustrated in FIG. 1. At step 460, the determined query plan may be executed. For example, the determined query plan may be performed out by the query engine 132 illustrated in FIG. 1. At step 470, the query results may be returned. For example, the query results produced by query engine 132 may be presented to a user in the query tool 108. After step 470, the method 400 terminates.

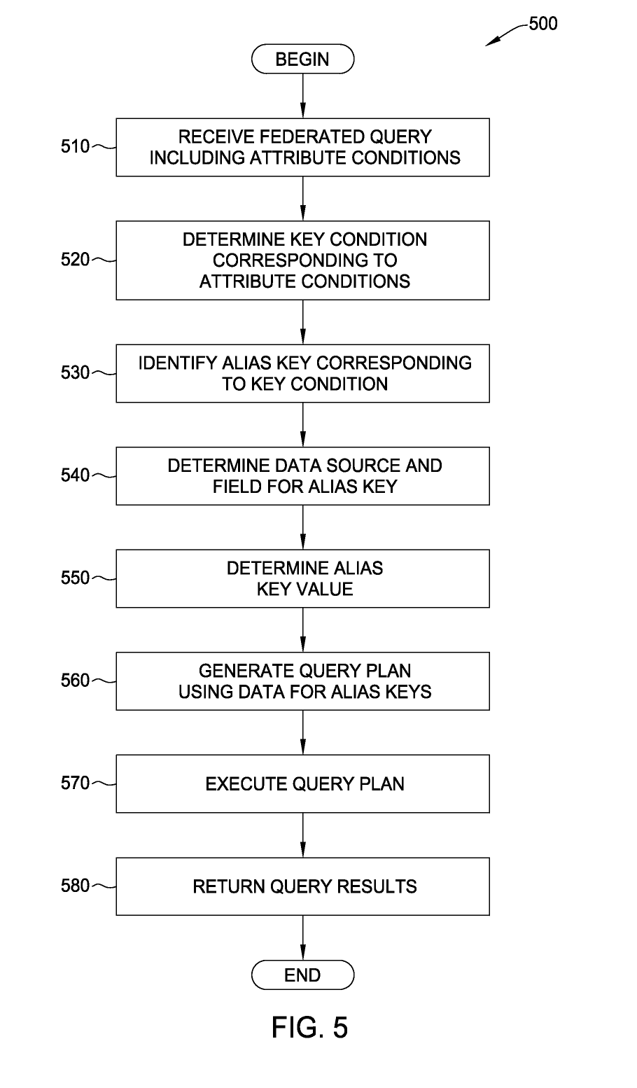

FIG. 5 is a flow diagram illustrating a method 500 for performing a parameter-based federated query using aliased keys, according to one embodiment of the invention. Persons skilled in the art will understand that, even though the method is described in conjunction with the systems of FIGS. 1-3, any system configured to perform the steps of method 500, in any order, is within the scope of the present invention.

The method 500 begins at step 510, when a federated query including attribute conditions is received. That is, a query may be received that is configured to retrieve data from multiple data sources, and which includes a query condition specifying attributes describing an entity (or entities) for which data is desired. For example, a federated query including an attribute condition may be created by a user interacting with a query tool 108, and may be received by a FDMS 130 on a federation server system 120. The federated query may be used to retrieve data records that match the attribute condition from multiple data sources 150_{1-N}.

At step 520, a key condition that matches the attribute conditions may be determined. That is, a key field and key value of a given data source may be determined, such that the entity corresponding to the key value satisfies the attribute conditions. For example, a federated query may include attribute conditions specifying that the name and age of a patient of a hospital, and may be used to retrieve the patient's records from multiple data sources. Step 520 may be performed, for example, by the FDMS 130 illustrated in FIG. 1. However, if the attribute conditions are insufficiently precise to match a particular entity at step 520, an alert message may be raised. Optionally, if multiple entities match the attribute conditions, a user may be presented with a screen interface listing the multiple entities, and which is configured to enable the user to select the entity desired for the query. At step 530, an alias key corresponding to the key condition is determined. The alias key may be determined, for example, by aliased key translator 136 interacting with aliased keys table 146, as illustrated in FIG. 1.

At step 540, the data source and field of the alias key may be determined. That is, a key field of a second data source may be determined be equivalent to the key field of the key condition. This determination may be made, for example, by using an aliased keys table 146. At step 550, the key value of the key condition may used to determine an alias key value. The alias key value corresponds to the same entity identified by the key value of the key condition. The step 550 may be performed using a mapping function configured to determine equivalent key values.

At step 560, a query plan to perform the federated query may be generated using the alias key data (i.e., the alias key data source, the alias key field, and the alias key value). In other words, the query plan may be generated to retrieve data from multiple data sources, without requiring that the key data of multiple data sources be specified in the initial query. Step 560 may be performed, for example, by FDMS 130 illustrated in FIG. 1. At step 570, the determined query plan may be followed in order to execute the query. For example, the determined query plan may be carried out by the query engine 132 illustrated in FIG. 1. At step 580, the query results may be returned. For example, the query results produced by query engine 132 according to the determined query plan may be presented to a user in the query tool 108. After step 580, the method 500 terminates.

While the foregoing is directed to embodiments of the present invention, other and further embodiments of the invention may be devised without departing from the basic scope thereof, and the scope thereof is determined by the claims that follow.

What is claimed is:

1. A computer-implemented method for processing for a federated query, comprising:
receiving the federated query, wherein the federated query requests data records stored in at least two data sources;
determining one or more conditions included in the federated query, wherein the one or more conditions specify a first key field from a first data source and a second key field from a second data source;
determining an alias relationship between the first key field and the second key field;
determining, based on the alias relationship, a mapping of key values of the first key field to key values of the second key field, wherein the mapping specifies that a key value of the first key field and a key value of the second key field identify the same entity;
generating a query plan for the federated query, wherein the query plan includes the mapping of key values of the first key field to key values of the second key field, and
outputting the generated query plan.

2. The computer-implemented method of claim 1, further comprising:
executing the generated query plan to retrieve a set of query results from at least the first data source and the second data source consistent with one or more conditions included in the federated query; and
returning the set of query results.

3. The computer-implemented method of claim 1, wherein determining an alias relationship is performed using a data structure storing one or more alias relationships, wherein each alias relationship specifies at least two key fields, and wherein each key field is from a different data source.

4. The computer-implemented method of claim 3, wherein the mapping of key values of the first key field to key values of the second key field is performed using a mapping function, wherein the mapping function is stored in the data structure storing one or more alias relationships.

5. The computer-implemented method of claim 4, wherein the mapping function is an SQL query for retrieving pairs of equivalent values from a mapping table, wherein the mapping table is configured to store pairs of equivalent values of key fields from different data sources.

6. The computer-implemented method of claim 4, wherein the mapping function identifies an address for a web service, wherein the web service is configured to return equivalent values for keys of different data sources.

7. The computer-implemented method of claim 1, wherein the federated query specifies one or more attributes, and wherein determining one or more conditions included in the federated query comprises:
identifying an entity corresponding to the specified one or more attributes; and
determining one or more conditions corresponding to the identified entity.

8. The computer-implemented method of claim 7, further comprising, prior to identifying an entity corresponding to the specified one or more attributes:
determining that the specified one or more attributes are insufficient to uniquely identify the entity; and
prompting for additional attributes sufficient to uniquely identify the entity.

9. A computer-readable storage medium including a program, which when executed on a processor performs an operation for generating a query plan for a federated query, the operation comprising:
receiving the federated query, wherein the federated query requests data records stored in at least two data sources;
determining one or more conditions included in the federated query, wherein the one or more conditions specify a first key field from a first data source and a second key field from a second data source;
determining an alias relationship between the first key field and the second key field;
determining, based on the alias relationship, a mapping of key values of the first key field to key values of the second key field, wherein the mapping specifies that a key value of the first key field and a key value of the second key field identify the same entity;
generating a query plan for the federated query, wherein the query plan includes the mapping of key values of the first key field to key values of the second key field, and
outputting the generated query plan.

10. The computer-readable storage medium of claim 9, wherein the operation further comprises:
executing the generated query plan to retrieve a set of query results from at least the first data source and the second data source consistent with one or more conditions included in the federated query; and
returning the set of query results.

11. The computer-readable storage medium of claim 9, wherein determining an alias relationship is performed using a data structure storing one or more alias relationships, wherein each alias relationship specifies at least two key fields, and wherein each key field is from a different data source.

12. The computer-readable storage medium of claim 11, wherein the mapping of key values of the first key field to key values of the second key field is performed using a mapping function, wherein the mapping function is stored in the data structure storing one or more alias relationships.

13. The computer-readable storage medium of claim 12, wherein the mapping function is an SQL query for retrieving pairs of equivalent values from a mapping table, wherein the mapping table is configured to store pairs of equivalent values of key fields from different data sources.

14. The computer-readable storage medium of claim 12, wherein the mapping function identifies an address for a web service, wherein the web service is configured to return equivalent values for keys of different data sources.

15. The computer-readable storage medium of claim 9, wherein the federated query specifies one or more attributes, and wherein determining one or more conditions included in the federated query comprises:
identifying an entity corresponding to the specified one or more attributes; and
determining one or more conditions corresponding to the identified entity.

16. The computer-readable storage medium of claim 15, wherein the operation further comprises, prior to identifying an entity corresponding to the specified one or more attributes:
determining that the specified one or more attributes are insufficient to uniquely identify the entity; and
prompting for additional attributes sufficient to uniquely identify the entity.

17. A system, comprising:
a federated database;
a processor; and
a memory containing a program, which when executed by the processor is configured to generate a query plan for a federated query of the federated database, wherein the program is configured to:
receive the federated query, wherein the federated query requests data records stored in at least two data sources;
determine one or more conditions included in the federated query, wherein the one or more conditions specify a first key field from a first data source and a second key field from a second data source;
determine an alias relationship between the first key field and the second key field;
determine, based on the alias relationship, a mapping of key values of the first key field to key values of the second key field, wherein the mapping specifies that a key value of the first key field and a key value of the second key field identify the same entity;
generate a query plan for the federated query, wherein the query plan includes the mapping of key values of the first key field to key values of the second key field, and
output the generated query plan.

18. The system of claim 17, wherein the program is further configured to:
execute the generated query plan to retrieve a set of query results from at least the first data source and the second data source consistent with one or more conditions included in the federated query; and
return the set of query results.

19. The system of claim 17, wherein the alias relationship is determined using a data structure storing one or more alias relationships, wherein each alias relationship specifies at least two key fields, and wherein each key field is from a different data source.

20. The system of claim 19, wherein the mapping of key values of the first key field to key values of the second key field is performed using a mapping function, wherein the mapping function is stored in the data structure storing one or more alias relationships.

21. The system of claim 20, wherein the mapping function is a SQL query for retrieving pairs of equivalent values from a mapping table, wherein the mapping table is configured to store pairs of equivalent values of key fields from different data sources.

22. The system of claim 20, wherein the mapping function identifies an address for a web service, wherein the web service is configured to return equivalent values for keys of different data sources.

23. The system of claim 17, wherein the federated query specifies one or more attributes, and wherein determining one or more conditions included in the federated query comprises:
identifying an entity corresponding to the specified one or more attributes; and
determining one or more conditions corresponding to the identified entity.

24. The system of claim 24, wherein the program further comprises, prior to identifying an entity corresponding to the specified one or more attributes:
determine that the specified one or more attributes are insufficient to uniquely identify the entity; and
prompt for additional attributes sufficient to uniquely identify the entity.

25. A computer-implemented method for processing for a federated query, comprising:
receiving the federated query, wherein the federated query requests data records stored in at least two data sources;
determining a key condition included in the federated query, wherein the key condition specifies a key field and a key value;
identifying one or more alias keys corresponding to the key field of the key condition;
determining, for each alias key, an alias key value corresponding to the key value of the key condition;
generating a query plan for the federated query, wherein the query plan includes the determined alias keys and alias key values, and
outputting the generated query plan.
